(19) United States
(12) Patent Application Publication
(10) Pub. No.: US 2010/0070720 A1
(43) Pub. Date: Mar. 18, 2010

(54) MEMORY ACCESS METHOD

(75) Inventors: Yukikazu Kuramoto, Osaka (JP); Daigo Senoo, Osaka (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/447,320

(22) PCT Filed: Oct. 22, 2007
(86) PCT No.: PCT/JP2007/070518

§ 371 Date: Apr. 27, 2009

(30) Foreign Application Priority Data
Oct. 27, 2006 (JP) 2006-293330

(51) Int. Cl. G06F 12/00; G06F 12/08

(52) U.S. Cl. 711/154; 711/203; 711/E12.001; 711/E12.058

(57) ABSTRACT

The memory access method of the present invention comprises preparing upper addresses separately from the address width of the Pseudo SRAM (200) as virtual addresses at cutting out inspection patterns, and utilizing the Pseudo SRAM (200) as a test memory having the address width of the internal CPU (101). Then, while there are only actual addresses in the number which corresponds to the memory capacity, when the memory is accessed with exceeding the actual address value at the inspection, the actual address and virtual address are distinguished from each other based on the number of times of accesses.

Thereby, the extension of addresses up to the number of addresses which are used in the internal CPU is performed to the maximum, and thereby the address insufficiency at using the real memory is solved.

### TECHNICAL FIELD

The present invention relates to a memory access method that utilizes a central processing unit.

### BACKGROUND ART

A conventional test system utilizing a conventional central processing unit will be described with reference to FIG. 4.

In FIG. 4, a semiconductor chip 10 includes a central processing unit (CPU) 11 and a bus controller unit (BCU) 12, and performs an address test by using a Pseudo SRAM (Pseudo Static Random Access Memory) 20. Here, the bit width of the CPU 11 is taken as 32 bits, and the bit width of the Pseudo SRAM 20 is taken as 13 bits. In addition, the memory capacity of the Pseudo SRAM 20 is made as 8 KB, and the real memory addresses of the Pseudo SRAM are made as 0×0000˜0×1FFF.

The conventional test system utilizing the semiconductor chip 10 constructed as described above will be described with reference to FIG. 5.

FIG. 5 shows an example of an address map of the Pseudo SRAM 20. It is assumed that an area from the address 0×0000 to address 0×1FFF is disposed in the address space of the Pseudo SRAM, and a case where an address test is performed with an 8 bit unit.

In case of FIG. 5, since the Pseudo SRAM 20 is in a 13 bit configuration while the CPU 11 is in a 32 bit configuration, there would occur address insufficiency (overflow).

Consequently, when further upper addresses are designated exceeding the actual memory addresses 0×0000 to 0×1FFF of the Pseudo SRAM 20 by the CPU 11, it returns to top address 0×0000 and to the portion which has over-flown, addresses from the top address are successively assigned, thereby solving the address insufficiency.

For example, when the inspection data are written in with designating addresses in a range of 0×2000 to 0×3FFF, since the actual addresses of the Pseudo SRAM 20 are 0×0000 to 0×1FFF, the designated addresses 0×2000 to 0×3FFF are converted into the actual addresses 0×0000 to 0×1FFF by the BCU 12, and thereby the writing in of the inspection data are performed. In addition, when the addresses 0×2000 to 0×3FFF are designated so as to read out the written in inspection data, the data are read out from the addresses 0×0000 to 0×1FFF which are relatively the same as the designated addresses. Then, whether the written in inspection data and the read out data are coincident with each other is judged and when they are coincident with each other, it is judged as it is normal.

Similarly, when the addresses in the ranges of 0×4000 to 0×5FFF and of 0×8000 to 0×9FFF are specified, these addresses are converted into the addresses 0×0000 to 0×1FFF which are relatively the same address as these addresses, and the memory accesses are performed to these address regions so as to perform writing in/reading out of data.

In the conventional inspection system as described above, the address insufficiency is solved by recognizing that the addresses 0×2000, 0×4000 and 0×8000 are relatively the same addresses as the actual address 0×1FFF, respectively.

Patent Document 1: Japanese Published Patent Application No. Sho. 57-169860

Patent Document 2: U.S. Pat. No. 5,699,539

### DISCLOSURE OF THE INVENTION

### Problems to be Solved by the Invention

However, in the conventional inspection system, following problems may occur.

While when an inspection is performed, the data required for the inspection is stored in a memory, as the memory capacity which is actually used, only the memory that is absolutely necessary which will be used in the actual operation was mounted, the data amount which can be stored in a memory is restricted depending on the memory capacity, and it was impossible to store inspection data of the amount which would exceed the memory capacity.

In addition, in case of FIG. 5, when an inspection is performed with using the inspection data A, the inspection can be performed with writing in the inspection data A into the region of addresses 0×0000 to 0×1FFF, while when the inspection is to be performed with using the other inspection data B, it is necessary to carry out a work of replacing the inspection data A which was written in into the region of addresses 0×0000 to 0×1FFF by the inspection data B.

In order to solve such problems, there is proposed a method which can secure the data region required for inspection by increasing the total capacity of the memory when the data amount required for the inspection exceeds the capacity of the memory. However, if a lot of inspections are to be carried out, the capacity of the memory for storing the inspection data would increase, thereby increasing the inspection cost.

The present invention is directed to solving the above-described problems and has for its object to provide a memory access method which can solve the address insufficiency when using a real memory.

### MEASURES TO SOLVE THE PROBLEMS

In order to solve the above-described problems, according to Claim 1 of the present invention, there is provided a memory access method which comprises accessing to addresses which are upper than actual addresses of a memory being enabled based on the number of times of accesses to the same address of the memory, whereby insufficiency of the actual addresses at using the memory is dissolved.

Thereby, the accessing is enabled even exceeding the memory capacity the limitation of which is determined by the number of address lines, thereby the insufficiency of the memory capacity is solved.

According to Claim 2 of the present invention, in a memory access method as defined in Claim 1, upper addresses of the memory are assumed with using a master memory for outputting plural kinds of instructions, the actual addresses and virtual addresses of the memory are distinguished based on the number of times of accesses to the memory, and writing in or reading out of different data are carried out into/from each of the actual addresses and the virtual addresses.

Thereby, the memory can be utilized as a memory having the bit width of the master memory.

According to Claim 3 of the present invention, in a memory access method as defined in Claim 1, it is configured such that inspection data are written in into predetermined address region of the memory, data are read out with designating the address region, and an inspection as to whether the read out data are coincident with the written in data is performed.

Thereby, the accessing is enabled even exceeding the memory capacity the limitation of which is determined by the number of address lines, thereby the insufficiency of the memory capacity is solved.

According to Claim 4 of the present invention, in a memory access method as defined in Claim 3, upper addresses of the memory are assumed with using a master memory for outputting plural kinds of instructions, the actual addresses and virtual addresses of the memory are distinguished based on the number of times of accesses to the memory, and second inspection data which are different from the data which are written in into the actual addresses of the memory are written in into the virtual addresses of the memory, the data are read out with designating the virtual memory addresses, and an inspection as to whether the read out data are coincident with the second inspection data is carried out.

Thereby, the memory can be utilized as a memory having, for example, the bit-width of the internal CPU, and thereby it is possible to store different data into the actual memory addresses and the virtual addresses.

### EFFECTS OF THE INVENTION

According to the memory access method of the present invention, by assuming upper bits which are different from the original bit width to the pseudo addresses when cutting out as the inspection pattern, the addresses can be expanded to the address amount which are used in the internal CPU at the maximum, and thereby the address insufficiency when using the real memory is solved.

According to the present invention, it is configured such that the actual addresses and virtual addresses of the memory are distinguished based on the number of times of accesses to the memory, thereby different data can be written in into the actual addresses and the virtual addresses.

### BRIEF DESCRIPTION OF THE DRAWINGS

FIG. 1 is a diagram illustrating a constitution of a semiconductor chip and a memory according to a first embodiment of the present invention.

FIG. 2 is a diagram illustrating a memory map in the first embodiment.

FIG. 3 is a diagram for explaining the memory access method according to the first embodiment.

FIG. 4 is a diagram illustrating a constitution of a conventional semiconductor chip and memory.

FIG. 5 is a diagram illustrating a conventional pseudo memory map.

### DESCRIPTION OF REFERENCE NUMERALS

10 . . . semiconductor chip
11 . . . CPU
12 . . . BCU
20 . . . Pseudo SRAM
100 . . . semiconductor chip
101 . . . CPU
102 . . . BCU
200 . . . Pseudo SRAM

### BEST MODE TO EXECUTE THE INVENTION

### Embodiment 1

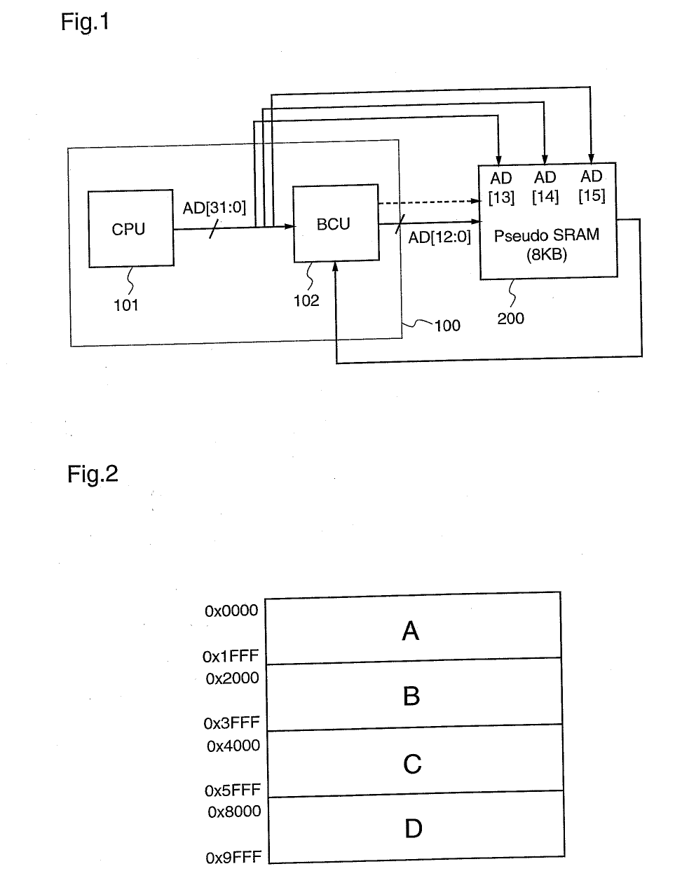

FIG. 1 is a diagram illustrating a memory access system according to a first embodiment of the present invention.

In FIG. 1, a semiconductor chip 100 has a central processing unit (CPU) 101 and a bus controller unit (BCU) 102, and performs an address test with utilizing Pseudo SRAM (Pseudo Static Random Access Memory) 200.

The CPU 101 is a memory master which outputs various kinds of instructions in synchronization with clocks. In this embodiment, as the CPU 101, a CPU of 32 bit width is used. However, it is not particularly limited by the performance and the kind, and a general CPU can be employed.

The BCU 102 performs a control between the CPU 101 and the Pseudo SRAM 200, and performs writing and reading of data into/from the Pseudo SRAM 200 on the basis of the control from the CPU 101.

The Pseudo SRAM 200 has addresses which correspond to the addresses used in the CPU one by one. In this embodiment, the memory capacity of the Pseudo SRAM 200 is 8 KB, and the bit width thereof is 13 bits.

FIG. 2 shows an address space of the Pseudo SRAM 200.

Memory addresses 0×0000˜0×1FFF are actual address values, and memory addresses 0×2000˜0×9FFF are extended addresses values.

Here, the address extension of the Pseudo SRAM will be described.

Usually, when the CPU has designated upper bits of the Pseudo SRAM, the portion of the memory which has over-flown is mirrored as shown in FIG. 5. In the present invention, this point is utilized to prepare upper bits at cutting out the inspection pattern. More particularly, when producing inspection patterns in a PC tester, upper bits which do not actually exist are added so as to virtually increase the memory capacity. Then, since the distinction between the address 0×0000 and the over-flown address 0×2000 can be performed based on the differences in timings, i.e., based on the number of times of accesses to the memory, it can be utilized as a memory having the bit width of the memory.

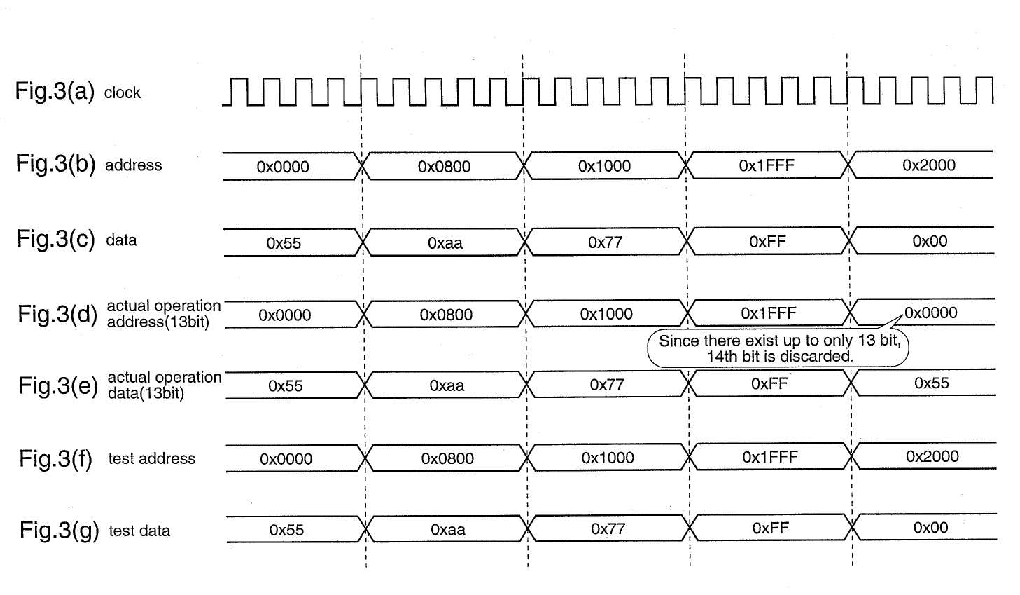

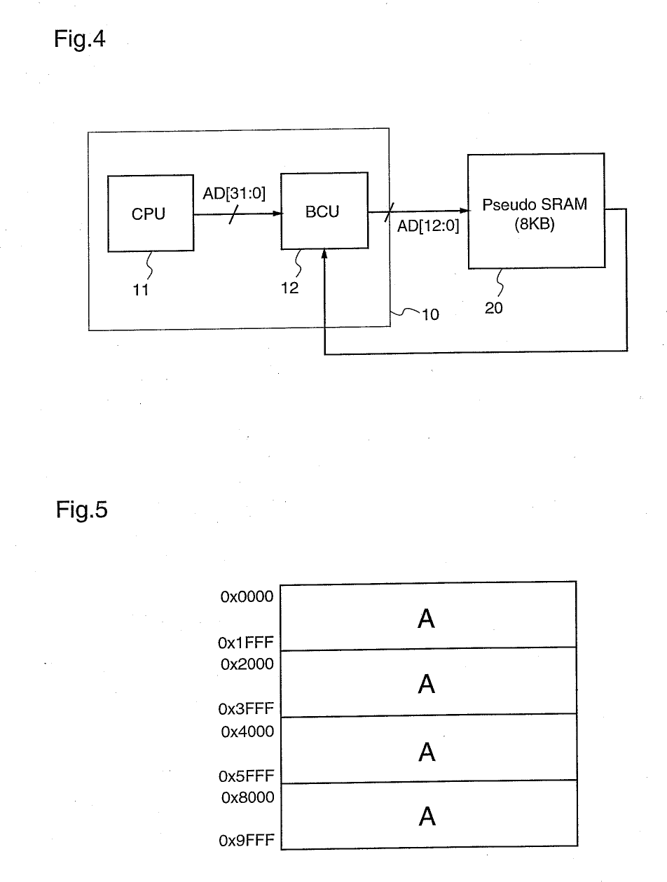

Hereinafter, the memory access method according to first embodiment of the present invention will be described with reference to FIG. 3.

In FIG. 3, (a) shows clock, (b) shows address, (c) shows data, (d) shows actual operation address, (e) shows actual operation data, (f) shows test address, and (g) shows test data, respectively.

First, the address extension when performing an inspection will be described.

In this embodiment, since the bit width of the Pseudo SRAM 200 is 13 bits and addresses thereof are 0×0000˜0×1FFF while the bit width of the CPU 101 is 32 bits, there occurs address insufficiency at using the memory.

In order to solve the address insufficiency, upper bits which exceed the memory capacity, i.e., AD[13], AD[14], AD[15] are (virtually) prepared as shown in FIG. 2.

After the address extension is carried out in this way, the CPU 101 designates addresses as shown in FIG. 3(b), and writes the data into the Pseudo SRAM 200 as shown in FIG. 3(c). For example, data 0×55 is written in into the address 0×0000, data 0×aa is written in into the address 0×0800, data 0×77 is written in into the address 0×1000, data 0×FF is written in into the address 0×1FFF, and, data 0×00 is written in into the address 0×2000, respectively.

Next, a memory access method in a case where addresses shown in FIG. 3(d) are designated at the actual operation will be described.

When the designated address is 0×0000, data 0×55 which is the same as the written data is read out. When the designated addresses are actual addresses up to 0×1FFF, data which are the same as the written data are read out.

However, since in the actual operation, upper addresses of the memory upper than 13 bits are mirrored, and 0×0000 and 0×2000 are recognized as the same, when the designated address is virtual address 0×2000, data 0×55 which is written data at the address 0×000 is read out. Similarly, also when the address is other virtual address, the data which was written in into the corresponding actual address is read out.

Next, a case where the test data that is operated by a tester which is synchronized with clocks is cut out at carrying out the inspection will be described.

If the address shown in FIG. 3(f) is designated, when the designated address is 0×0000, data 0×55 which is the same as the written in data is read out. Similarly, when the designated address is an actual address up to 0×1FFF, the data which is the same as the written in data is read out. In addition, when address 0×2000 which is upper than the actual address 0×1FFF is designated, since the actual address and virtual address can be distinguished based on the number of times of accesses to the Pseudo SRAM 200 at carrying out the inspection, data 0×00 which is the same as the written in data can be read out.

As described above, since while the address 0×2000 and the address 0×0000 are recognized as the same addresses at the actual operation due to that the actual address of the memory is 0×0000 to 0×1FFF, the address 0×2000 and the address 0×0000 can be distinguished based on the number of times of accesses to the Pseudo RAM 200 at the inspection, the Pseudo SRAM 200 can be utilized as a test memory having the address bit width that is used in the CPU 101, i.e., 32 bits here.

In addition, since no test pattern of a tester which performs a test in synchronization with clocks is required in the actual operation, no upper bits are required in an actual memory.

Consequently, the virtual address and the actual address are distinguished from each other based on the difference in the operation timings in the 14-th and subsequent bits of the CPU 101, i.e., the number of times of accesses to the Pseudo SRAM 200 as shown in FIG. 1. For example, it is possible to recognize the virtual addresses 0×2000, 0×4000, 0×8000 and the actual address 0×0000 which is relatively the same address as these addresses as different addresses only at the inspection, and thereby it is possible to read out inspection data B from address 0×2000, inspection data C from address 0×4000, and inspection data D from address 0×8000, respectively.

In this way, according to the memory access method of the first embodiment, it is possible to read out different data from 0×0000 and from 0×2000 even when these have the same address as a memory area by (virtually) adding upper bits thereto as shown in FIG. 2, and thereby it is possible to dispose data which are required for performing a test without being restricted to the limited memory area. Thereby, it is possible to store different inspection data in the extended address regions and implement a plurality of inspection patterns without replacing inspection data as in the prior art. In addition, since when performing a memory access with exceeding the actual address, distinction between the actual addresses and the upper addresses upper than the actual addresses can be carried out based on the differences in operation timings at performing a test, the address width which is required for the actual operation is only necessarily prepared as the address width of the memory, with having no concern on the test operation. This results in no necessity of adding terminals dedicated for test in an actual chip, which further leads to reduction in the terminal number in an actual chip.

### APPLICABILITY IN INDUSTRY

According to a memory access method of the present invention, there is no necessity of increasing the addresses of the actual memory for performing a test, and it is effective in reducing the number of terminals.

1. A memory access method, comprising:
accessing to addresses which are upper than actual addresses of a memory being enabled based on the number of times of accesses to the same address of said memory, whereby insufficiency of the actual addresses at using said memory is dissolved.

2. A memory access method as defined in claim 1, wherein
upper addresses of said memory are assumed with using a master memory for outputting plural kinds of instructions,
the actual addresses and virtual addresses of said memory are distinguished based on the number of times of accesses to said memory, and
writing in or reading out of different data are carried out into/from each of said actual addresses and said virtual addresses.

3. A memory access method as defined in claim 1, wherein
it is configured such that inspection data are written in into predetermined address region of said memory, data are read out with designating said address region, and an inspection as to whether the read out data are coincident with said written in data is performed.

4. A memory access method as defined in claim 3, wherein
upper addresses of said memory are assumed with using a master memory for outputting plural kinds of instructions,
the actual addresses and virtual addresses of said memory are distinguished based on the number of times of accesses to said memory, and
second inspection data which are different from the data which are written in into the actual addresses of said memory are written in into said virtual addresses of said memory, the data are read out with designating said virtual memory addresses, and an inspection as to whether said read out data are coincident with said second inspection data is carried out.
